(19) United States
(12) Patent Application Publication
(10) Pub. No.: US 2024/0271517 A1
(43) Pub. Date: Aug. 15, 2024

(54) SYSTEM FOR ENVIRONMENTAL REMEDIATION WITH SPONGE

(71) Applicant: Chevron U.S.A. Inc., San Ramon, CA (US)

(72) Inventor: Daniel Concannon Segal, Oakland, CA (US)

(21) Appl. No.: 18/169,139

(22) Filed: Feb. 14, 2023

(51) Int. Cl. E21B 43/38; B01D 17/04; C02F 1/40; E21B 34/08; E21B 43/08; E21B 43/12

(52) U.S. Cl. CPC E21B 43/38; B01D 17/045; C02F 1/40; E21B 34/08; E21B 43/08; E21B 43/12; C02F 2101/32; C02F 2303/16

(57) ABSTRACT

The present invention is a system including an oleophilic sponge and a pump assembly. The system is designed to remove non-aqueous phase liquids (NAPLs) from water. The pump includes a filter through which NAPLs are absorbed into the sponge. The pump compresses the sponge, thereby releasing the NAPLs into the annulus of the pump assembly. The NAPLs can then be easily removed or treated.

### FIELD OF THE DISCLOSURE

The present disclosure relates to a system for removing contaminants from water.

### BACKGROUND AND SUMMARY

Extraction of oil and other non-aqueous phase liquids (e.g., refined petroleum hydrocarbons) from wells, either for oil production or environmental remediation purposes, currently requires the extraction of all reservoir fluids to the surface, including large volumes of water, which need to be separated and disposed of as a waste. Wastewater handling makes up a significant cost due to the increased energy required to lift these unwanted fluids from the reservoir, requires oil water separation surface facilities, as well as wastewater disposal costs.

Therefore, there is a need to provide a system and method that overcome these deficiencies.

Aspects of the disclosed embodiments include an oleophilic sponge and plunger system configured to remove non-aqueous phase liquids (NAPLs) from water.

Embodiments of the present disclosure provide a method of separation and recovery of non-aqueous phase liquids (NAPL) from water, comprising: positioning an oleophilic sponge in a cased interval located within a subsurface formation, thereby drawing fluids from the subsurface formation into the sponge; compressing the oleophilic sponge within the cased interval with a plunger of a plunger assembly, the plunger having a valve such that fluids flow from the sponge to an annulus of the plunger assembly; and removing the fluids from the annulus.

Embodiments of the present disclosure provide a system for removing non-aqueous liquids from water, comprising: a pump assembly comprising an exterior forming a housing, the housing further comprising a filter further comprising less than the whole of the exterior; a cased interval comprising the bottom of the pump assembly; a sponge configured to fit within the filter; a check pump; and a plunger assembly configured to compress the oleophilic sponge, such that one or more fluids flow from the sponge to an annulus of the plunger assembly.

Embodiments of the present disclosure provide a system for removing non-aqueous liquids from water, comprising: a remediation pump network comprising a plurality of pump assemblies, each pump assembly comprising: an exterior forming a housing, the housing further comprising a filter further comprising less than the whole of the exterior; a cased interval comprising the bottom of the pump assembly; a sponge configured to fit within the filter; a check pump; and a plunger assembly designed to compress the oleophilic sponge, such that one or more fluids flow from the sponge to an annulus of the plunger assembly.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

The invention relates generally to a system and method for using an oleophilic sponge and pump assembly for contaminant cleanup purposes. A device can be used to extract the oil from the sponge where it can be pumped to the surface. Oleophilic sponges are currently being developed for oil spill cleanup purposes and they may be able to be repurposed for this concept.

FIG. 1 illustrates a pump assembly according to an exemplary embodiment.

FIG. 2 illustrates a pump assembly according to an exemplary embodiment.

FIG. 3 illustrates a pump assembly according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Non-aqueous phase liquids (NAPLs) are organic liquid contaminants that do not dissolve in, or easily mix with, water (hydrophobic), like oil, gasoline and petroleum products. NAPLs tend to contaminate soil and groundwaters for very long period of time. Many common groundwater contaminants such as chlorinated solvents and many petroleum products enter the subsurface in nonaqueous-phase solutions. They do not mix readily with water and therefore flow separately from ground water.

The invention relates generally to a system and method for using an oleophilic sponge and pump assembly for oil spill cleanup purposes. A device can be used to extract the oil from the sponge where it can be pumped to the surface. Oleophilic sponges are currently being developed for oil spill cleanup purposes and they may be able to be repurposed for this concept. The oleophilic sponge can be place in a pump assembly which includes a plunger assembly, a check valve, and a filter. The sponge can fit within the filter. While the plunger is not engaged, the uncompressed sponge can absorb the contaminants. Then, the plunger can be engaged, thus compressing the sponge. The contaminants are squeezed out of the sponge, then past the check valve, then into an annulus of the pump assembly. The contaminants can be further removed or treated.

Systems and methods of the present disclosure provide numerous advantages. Reduced cost of production by reducing the energy required for lifting water, facilities needed for separating water, and disposing of wastewater. For environmental remediation, the oleophilic sponges may operate more effectively than skimmers, a technology that also does not produce wastewater, because the oleophilic sponges can use surface tension forces to draw in non-aqueous phase liquids (NAPL) from the aquifer, whereas skimmers only rely on gravity to transport NAPL to the well. Oleophilic sponges may produce NAPL faster and may reduce NAPL to lower levels than skimmers, which are ineffective at low concentrations.

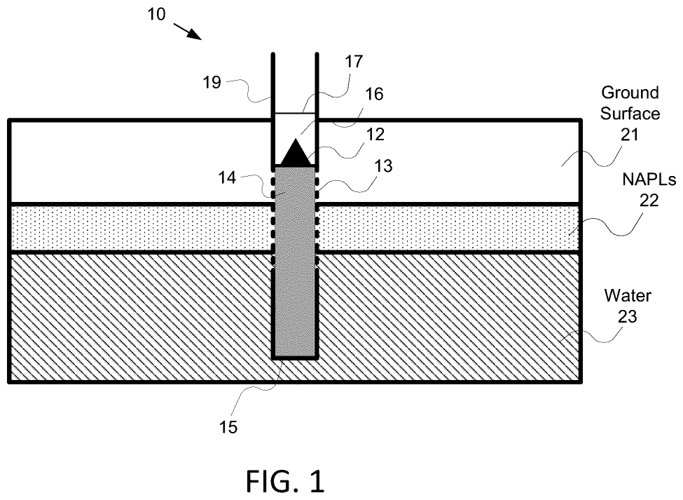

FIG. 1 illustrates a system with an oleophilic sponge 14 according to an exemplary embodiment. Generally, the system can be placed within a subsurface formation to reach ground water through one or more layers of earth.

FIG. 1 illustrates a system for removing unwanted materials or compositions from water table, water body, water reservoir, or other area containing water. The system can include check pump 10. It is understood that check pump 10 is one or more pump assemblies. Generally, each check pump 10 can include an exterior 19 forming a housing. The check pump 10 can include a check valve 12, well screen 13, cased interval 15, an oleophilic sponge 14, a plunger 17, and an annulus 16. The cased interval 15 can comprise the bottom of the pump check pump 10. The check pump 10 can be positioned such that the plunger 17 sits partially above the ground surface 21 and the check valve 12, well screen 13, and oleophilic sponge 14 sit partially next to the ground surface 21, one or more layers of NAPLs 22, and the ground water 23 such that the sponge 14 and/or filter 13 are positioned near the layer of NAPLs 22. For example, the check pump 10 can be inserted into the ground surface 21, past a layer of NAPLs 22 and into the ground water 23. The check pump 10 can be positioned such that the layer of NAPLs can go into the well screen 13. Although reference is made to NAPLs, it is understood that other nonaqueous liquids may be used. The NAPLs 22 pass the well screen 13 and come into contact with the oleophilic sponge 14. The oleophilic sponge 14 absorbs the NAPLs 22. The filter screen 13 ensures that other debris or detritus is not absorbed by the sponge 14.

Generally, the well screen is the component of a well which provides an opening through which water enters the well casing from the aquifer, as well as stabilizing the material in the “near-well zone” and preventing it from entering the well. Screens may be constructed with a variety of different materials and designs, as appropriate to the design of the well and its aquifers. The well designs can include without limitation: horizontal louver screens, or a pipe-based well screen with punch-formed downward facing louver-shaped openings; continuous wire wrap screens, manufactured by wrapping shaped wire around an internal array of rods; bridge slot screens, produced by rolling and welding perforated steel plates or sheets; machine-slotted (milled) screens, manufactured by milling casing with axially oriented precision cutters; and well casing perforated in place with a mills knife or a hydraulic perforator lowered down the cased borehole.

The check valve, non-return valve, reflux valve, retention valve, foot valve, or one-way valve is a valve that normally allows fluid (liquid or gas) to flow through it in only one direction. An important concept in check valves is the cracking pressure which is the minimum differential upstream pressure between inlet and outlet at which the valve will operate. Typically, the check valve is designed for and can therefore be specified for a specific cracking pressure. Cracking pressure is also known as unseating head (pressure) or opening pressure.

Types of check valves can include without limitation: Ball check valve, diaphragm check valve, swing check valve or tilting disc check valve, clapper valve, stop-check valve, lift-check valve, in-line check valve, duckbill valve, pneumatic non-return valve, reed valve, and flow check. Altogether, these elements can come together to form a remediation well, or a well that is used to clean up, treat, or prevent contamination of ground water.

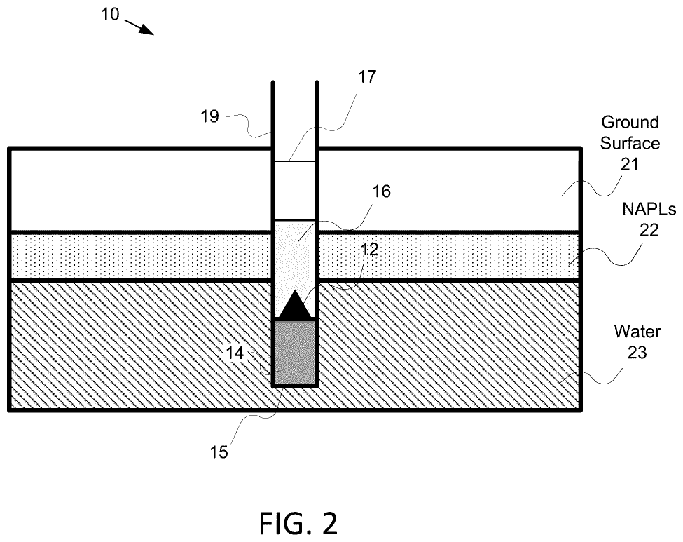

FIG. 2 illustrates a system for remediating ground water according to an exemplary embodiment.

The plunger 17 is depressed to isolate the well screen 13 and squeeze the oleophilic sponge 14. Thus, the NAPL is displaced from the sponge 14 into the annulus of the pump 10 through a check valve 12.

After the letting the oleophilic sponge 14 absorb NAPLs, the pump 10 can be depressed by a mechanical or electrical power. The check valve 12 is forced down the pump close to the floor. Thus, the sponge 14 contained between the check valve 12 and the floor is squeezed or depressed. As the sponge 14 is squeezed, the crack pressure associated with the check valve 12 is met, and the NAPLs flow through the check valve 12 into the annulus 16.

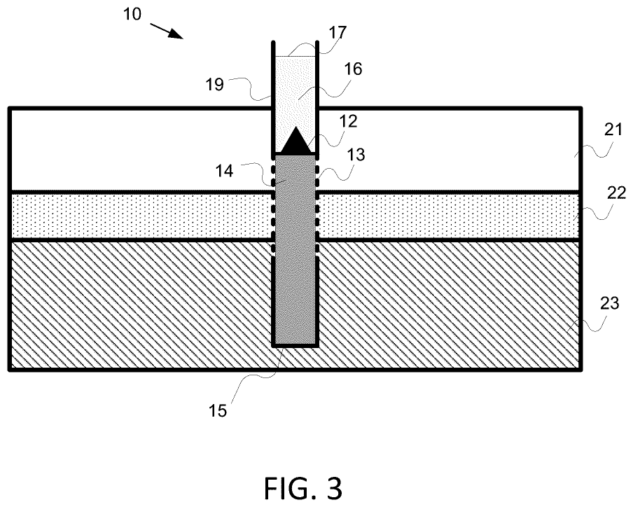

FIG. 3 illustrates a system for remediating ground water according to an exemplary embodiment.

The plunger 17 is released, thus decompressing the sponge 14. Because the crack pressure is no longer initiated, the check valve 12 acts a floor to the check pump 10. The liquids in the annulus 16 are lifted to the top of the check pump 10 where they can be disposed of. The oleophilic sponge 14 is stretched back into place contacting with the well screen 13.

The check pump 10 can have several variations not otherwise shown in the figures. As a nonlimiting example, the check pump can be configured to have a detachable well screen, have two or more oleophilic sponges, have a larger well screen, have a shorter well screen, or have different cavities for storing NAPLs. In other embodiments, the system can comprise more than one check pumps. For example, some embodiments could include multiple check pumps working independently or in unison. This network of check pumps could clean up large areas. Each of these check pumps or pump assemblies can be connected into a remediation pump network, each with a plurality of pump assemblies. Each of these pump assemblies can be connected by one or more connecting members which can connect each pump to each other, connect each pump to a storage unit or storage assembly, or connect each pump to a treatment center.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

What is claimed is:

1. A method of separation and recovery of non-aqueous phase liquids (NAPL) from water, comprising:
positioning an oleophilic sponge in a cased interval located within a subsurface formation, thereby drawing fluids from the subsurface formation into the sponge;
compressing the oleophilic sponge within the cased interval with a plunger of a plunger assembly, the plunger having a valve such that fluids flow from the sponge to an annulus of the plunger assembly; and
removing the fluids from the annulus.

2. A system for removing non-aqueous liquids from water, comprising:
a pump assembly comprising
an exterior forming a housing, the housing further comprising a filter further comprising less than a whole of the exterior;
a cased interval comprising a bottom of the pump assembly;
a sponge configured to fit within the filter;
a check pump; and
a plunger assembly configured to compress the sponge, such that one or more fluids flow from the sponge to an annulus of the plunger assembly.

3. The system of claim 2, wherein the pump assembly is configured to house a plurality of sponges.

4. The system of claim 2, wherein the pump further comprises a removable screen cover.

5. The system of claim 2, wherein the pump is associated with a remediation well.

6. A system for removing non-aqueous liquids from water, comprising:
a remediation pump network comprising
a plurality of pump assemblies, each pump assembly comprising:
an exterior forming a housing, the housing further comprising a filter further comprising less than a whole of the exterior;
a cased interval comprising a bottom of the pump assembly;
a sponge configured to fit within the filter;
a check pump; and
a plunger assembly designed to compress the sponge, such that one or more fluids flow from the sponge to an annulus of the plunger assembly.

7. The system of claim 6, wherein the remediation pump network is configured to remove non aqueous phase liquids (NAPLs) from one or more bodies of water.

8. The system of claim 6, wherein the remediation pump network further comprises one or more connecting members configured to connect each pump assembly to one or more main storage assemblies.
